(19) United States
(12) Patent Application Publication
(10) Pub. No.: US 2025/0187479 A1
(43) Pub. Date: Jun. 12, 2025

(54) SYSTEMS AND METHODS FOR TRANSFERRING ENERGY FROM ELECTRIFIED VEHICLES

(71) Applicant: Ford Global Technologies, LLC, Dearborn, MI (US)

(72) Inventors: Richard Mo, Canton, MI (US); Timothy Harris, Grosse Ile, MI (US)

(21) Appl. No.: 18/530,826

(22) Filed: Dec. 6, 2023

(51) Int. Cl. B60L 53/66; B60L 53/53; B60L 53/55

(52) U.S. Cl. CPC B60L 53/66; B60L 53/53; B60L 53/55

(57) ABSTRACT

A bidirectional power transfer system includes: a power source within EVSE; a first switch that transitions to a closed state so that the power source within the EVSE can power communications between the EVSE and an electrified vehicle; and a second switch that transitions to a closed state so that the power source can be recharged from the electrified vehicle.

### TECHNICAL FIELD

This disclosure relates generally to electrified vehicles and, more particularly, to systems and methods for transferring energy from electrified vehicles to other structures.

### BACKGROUND

Electrified vehicles can include one or more charging interfaces. Electric Vehicle Supply Equipment (EVSE) can connect to one of these interfaces to charge a traction battery pack of the electrified vehicle. Plug-in electrified vehicles can be charged through EVSE while parked at a charging station or some other utility power source. Some plug-in electrified vehicles can also be used to support household loads during electrical power outages, to return power to the grid, or both.

### SUMMARY

In some aspects, the techniques described herein relate to a bidirectional power transfer system, including: a power source within EVSE; a first switch that transitions to a closed state so that the power source within the EVSE can power communications between the EVSE and an electrified vehicle; and a second switch that transitions to a closed state so that the power source can be recharged from the electrified vehicle.

In some aspects, the techniques described herein relate to a bidirectional power transfer system, wherein the power source is a battery.

In some aspects, the techniques described herein relate to a bidirectional power transfer system, wherein the battery is at least 13 Volts.

In some aspects, the techniques described herein relate to a bidirectional power transfer system, wherein the power source is capacitor.

In some aspects, the techniques described herein relate to a bidirectional power transfer system, wherein the power source is and ultracapacitor.

In some aspects, the techniques described herein relate to a bidirectional power transfer system, wherein the EVSE includes the first switch, the second switch, or both.

In some aspects, the techniques described herein relate to a bidirectional power transfer system, wherein communications from the EVSE to the electrified vehicle initiate a power transfer from the electrified vehicle, through the EVSE, to a structure that is operably coupled to the EVSE.

In some aspects, the techniques described herein relate to a bidirectional power transfer system, further including a third switch that transitions to a closed state so that power from the electrified vehicle can be used to power communications between the EVSE and the structure.

In some aspects, the techniques described herein relate to a bidirectional power transfer system, further including Ethernet cabling, the communications between the EVSE and the structure transferred along the Ethernet cabling.

In some aspects, the techniques described herein relate to a bidirectional power transfer system, further including a switched-mode power supply within the EVSE, the switched-mode power supply powered by the power from the electrified vehicle.

In some aspects, the techniques described herein relate to a bidirectional power transfer system, further including a boost circuit within the EVSE, the boost circuit boosting power received from the vehicle before transferring the power to the structure.

In some aspects, the techniques described herein relate to a bidirectional power transfer system, wherein the EVSE is configured to operably couple to a combiner box of the structure when the EVSE is transferring power from the electrified vehicle, through the EVSE, to a structure that is operably couple to the EVSE.

In some aspects, the techniques described herein relate to a bidirectional power transfer system, wherein the combiner is batteryless.

In some aspects, the techniques described herein relate to a power transfer method, including: powering communications between EVSE and an electrified vehicle using a power source within the EVSE; in response to the communications between the EVSE to the electrified vehicle, transferring power from the electrified vehicle through the EVSE to a structure; and recharging the power source within the EVSE during the transferring using power from the electrified vehicle.

In some aspects, the techniques described herein relate to a power transfer method, further including powering communications between the EVSE and the structure using power from the electrified vehicle.

In some aspects, the techniques described herein relate to a power transfer method, further including transitioning a first switch to an closed state to enable the power source to power the communications between the EVSE and the electrified vehicle, and transitioning the first switch to an open state when transferring power from the electrified vehicle through the EVSE to the structure.

In some aspects, the techniques described herein relate to a power transfer method, wherein the power source within EVSE is a battery that is no more than 13 Volts.

In some aspects, the techniques described herein relate to a power transfer method, further including, during the transferring, powering communications between the EVSE and the structure using power transferred to the EVSE from the electrified vehicle.

In some aspects, the techniques described herein relate to a power transfer method, wherein communications between the EVSE and the structure are Ethernet communications.

In some aspects, the techniques described herein relate to a power transfer method, further including transitioning at least one second switch from an open state to a closed state to enable the powering of communications between the EVSE and the structure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 a bidirectional power transfer system according to an exemplary aspect of the present disclosure.

FIG. 2 illustrates a schematic view of the bidirectional power transfer system of FIG. 1.

FIG. 3 illustrates a flow of a method of power transfer according to an exemplary aspect of the present disclosure.

### DETAILED DESCRIPTION

This disclosure relates to systems and methods for transferring energy from electrified vehicles through EVSE to other structures, such as a home. The EVSE includes a power source that powers initial communications from the EVSE to the electrified vehicle. The initial communications can prompt the electrified vehicle to start transferring energy through the EVSE to the other structures. Some of the energy transferred from the electrified vehicle can be used to recharge the power source.

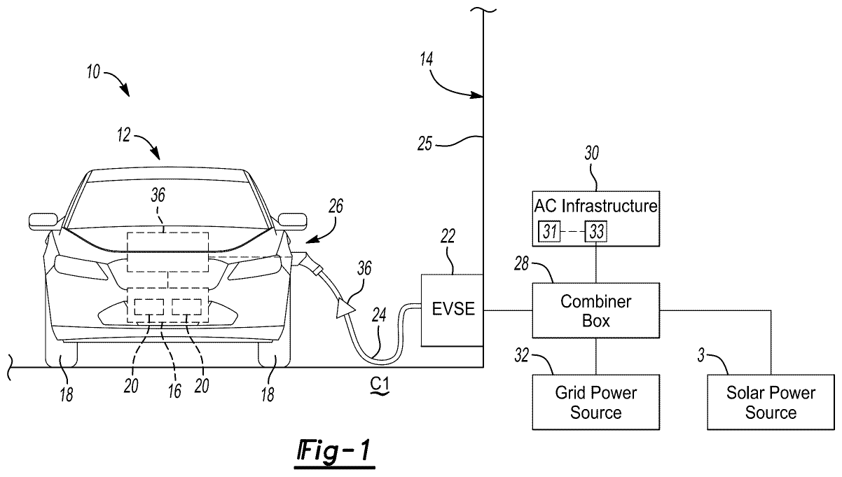

These and other features of this disclosure are discussed in greater detail in the following paragraphs of this detailed description. With reference to FIG. 1, an exemplary bidirectional energy transfer system 10 (hereinafter “the system 10”) for bidirectionally transferring energy between a vehicle 12 and a structure 14. The system 10 enables the bidirectional transfer of energy from the vehicle 12 to the structure 14 or vice versa. The structure 14 may be a residential building, a commercial building, a parking garage, a charging station, or any other type of structure that is capable of receiving or transferring energy. In an embodiment, the structure 14 is a residential household that functions as a “home location” of the vehicle 12.

Although a specific component relationship is illustrated in the figures of this disclosure, the illustrations are not intended to limit this disclosure. The placement and orientation of the various components of the depicted system are shown schematically and could vary within the scope of this disclosure. In addition, the various figures accompanying this disclosure are not necessarily drawn to scale, and some features may be exaggerated or minimized to emphasize certain details of a particular component.

In an embodiment, the vehicle 12 is a plug-in type electric vehicle (e.g., a plug-in hybrid electric vehicle (PHEV) or a battery electric vehicle (BEV)). The vehicle 12 includes a traction battery pack 16 that is part of an electrified powertrain capable of applying a torque from an electric machine (e.g., an electric motor) for driving wheels 18 of the vehicle 12. The electrified powertrain of the vehicle 12 may electrically propel the set of wheels 18 either with or without the assistance of an internal combustion engine.

The vehicle 12 is schematically illustrated as a car. However, other vehicle configurations are also contemplated. The teachings of this disclosure may be applicable for any type of vehicle as the vehicle 12. For example, the vehicle 12 could be configured as a car, a pickup truck, a van, a sport utility vehicle (SUV), etc.

Although shown schematically, the traction battery pack 16 may be configured as a high voltage traction battery pack that includes a plurality of battery arrays 20 (e.g., battery assemblies or groupings of battery cells) capable of outputting electrical power to one or more electric machines of the vehicle 12. Other types of energy storage devices and/or output devices may also be used to electrically power the vehicle 12.

The vehicle 12 may interface with the structure 14 through electric vehicle supply equipment (EVSE) 22 in order to perform the bidirectional energy transfers of the system 10. In an embodiment, the EVSE 22 is a wall box that may be mounted to a wall 25 of the structure 14.

A charge cable 24 may operably connect the EVSE 22 to a charge port assembly 26 of the vehicle 12 for transferring energy between the vehicle 12 and the structure 14. The charge cable 24 may be configured to provide any level of charging (e.g., 120 VAC, 240 VAC, Direct Current (DC) charging, etc.).

The EVSE 22 may be operably connected to an AC infrastructure 30 of the structure 14 through a combiner box 28, which is a type of bidirectional energy transfer module. Although shown separately from the EVSE 22 in FIG. 1 as part of the structure 14, the combiner box 28 and the EVSE 22 could be integrated together as part of common module.

Various electrical loads 31, such as household appliance loads, for example, may be associated with the AC infrastructure 30. The electrical loads 31 may sometimes be referred to as transient loads of the AC infrastructure 30 and could include loads associated with common kitchen appliances, washers, dryers, water heaters, air conditioning units, furnaces, home alarms systems, sump pump systems, routers, etc. The AC infrastructure 30 may further include a main service panel 33

Power from a grid power source 32, from a renewable power source 34, from the vehicle 12, or some combination of these can be selectively transferred to the AC infrastructure 30 for powering the electrical loads 31. The combiner box 28 can control power transfer to the AC infrastructure 30. The combiner box 28 can, in some example, further control power transfer to the grid power source 32. For example, power from the vehicle 12 could periodically be transferred through the combiner box 28 back to the grid power source 32.

In some examples, the combiner box 28 can activate a transfer switch to decouple the grid power source from the electrical loads 31, and then transfer power from the renewable power source 34, the vehicle 12, or both to the electrical loads 31.

Power received from or transferred to the vehicle 12 may be transferred through the combiner box 28, which is configured to aid bidirectional transfers of electrical energy between the vehicle 12 and the structure 14.

The vehicle 12 may further include a vehicle power transfer system 36 configured for further enabling the bidirectional transfer of power between the vehicle 12 and the structure 14. The vehicle power transfer system 36 may be operably connected between the charge port assembly 26 and the traction battery pack 16 of the vehicle 12. The vehicle power transfer system 36 may include various equipment for enabling the vehicle 12 to act as a backup power source for transferring power to the structure 14, such as a charger, a converter, an inverter, high voltage relays or contactors, a motor controller (which may be referred to as an inverter system controller or ISC), etc. The vehicle power transfer system 36 may further be configured to enable the vehicle 12 to receive power from the structure 14 and for transferring energy between the traction battery pack 16 and one or more electric motors of the vehicle 12.

One non-limiting example of a suitable vehicle power transfer system that may be employed for use within the vehicle 12 for achieving bidirectional power transfers is disclosed within US Patent Publication No. 2020/0324665, assigned to Ford Global Technologies, LLC, the disclosure of which is incorporated herein by reference. However, other power transfer systems could also be utilized for achieving bidirectional power transfers within the scope of this disclosure.

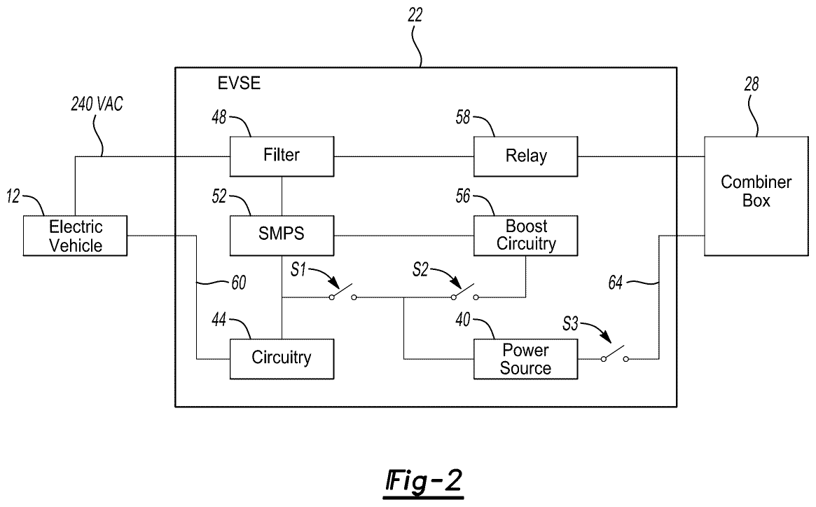

With reference to FIG. 2 and continuing reference to FIG. 1, the EVSE 22, in this example, is configured to communicate with the vehicle 12 and the combiner box 28 to facilitate transfers of power from the vehicle 12 to the electrical loads 31. The EVSE 22 is operably coupled to the vehicle 12 when transferring power from the vehicle 12. The EVSE 22 is operably coupled to the structure 14 through the combiner box 28.

As can be appreciated, the combiner box 28 is ordinarily powered by the grid power source 32. During a power outage where the grid power source 32 is not available, the combiner box 28 still may need to be powered to control the transfer of power from the vehicle 12 to the electrical loads. This is oftentimes referred to as a “dark start.”

The EVSE 22, in this example, includes features that enable the combiner box 28 and the EVSE 22 to communicate even when the grid power source 32 is unable to provide power to the combiner box 28. The features, notably, do not require the EVSE 22 to include a battery that is sized to power every function of the EVSE 22 and the combiner box 28, but rather selected functions.

The EVSE 22, in the exemplary embodiment includes a power source 40, circuitry 44, a first switch S1, a second switch S2, and a third switch S3. The EVSE 22 additionally includes a filter 48, a switched-mode power supply (SMPS) 52, boost circuitry 56, and one or more relays 58. The EVSE 22 includes a vehicle communication line 60 that can communicate data between the EVSE 22 and the vehicle 12. The EVSE 22 includes a combiner communication line 64 that can communicate data between the EVSE 22 and the combiner box 28.

During a dark start, the circuitry 44 can command the first switch S1 to transition to a closed state. The power source 40 then powers the circuitry 44, which sends communications between the EVSE 22 and the electrified vehicle 12 along the vehicle communication line 60. These communications initiate a power transfer from the electrified vehicle 12 to the EVSE 22.

The power source 40 can be no more than a 13 VDC power source, which is appropriate for pilot communications to the electrified vehicle 12 on the vehicle communication line 60. The power source 40 can be a battery, such as a 13 Volt battery. The power source 40 could instead be a capacitor, such as an ultracapacitor or a super capacitor. When lacking a battery, the EVSE 22 can be considered batteryless. In some examples, the power source 40 must be at least 13 Volts to ensure proper communications and to account for diode voltage drops, circuit tolerances in the system, or both.

The power can be 240 VAC power that is transferred to the filter 48 and then to the SMPS 52. In this example, the SMPS 52 is a dual-mode SMPS that can receive input power from the electrified vehicle 12, or through the combiner box 28 from the grid power source 32.

The SMPS 52, in this example, converts the 240 VAC input from the electrified vehicle 12 into 12 VDC output that can be used to power circuitry 44 within the EVSE 22. At this point, the first switch S1 can be transitioned back to an open state as the power source 40 is no longer needed to power the circuitry 44.

The 12 VDC output from the SMPS 52 also transfers to the boost circuitry 56. The second switch S2 is transitioned to a closed state so that the output from the boost circuitry 56 can recharge the power source 40. The 12 VDC output from the SMPS 42 need to be boosted, in this example, to charge the power source 40 while accounting for voltage drops over the length of the combiner communication line 64 and other lines due to cable resistance.

The third switch S3 is also now closed to that an output power from the power source 40, which is continually recharging, can power communications along the combiner communication line 64. These communications can be Power over Ethernet communications and the combiner communication line 64 can be an Ethernet line.

In response to the communications along the combiner communication line 64, the combiner box 28 wakes up and can start communications with the EVSE 22 over the combiner communication line 64. After a handshake between the combiner box 28 and the EVSE 22, the EVSE 22 can close relays to begin transferring power from the electrified vehicle 12 to the combiner box 28.

The power source 40 can be part of the bill of materials for the EVSE 22 and is not, in this example, necessary for typical AC based charge. The power source 40 can be added to the EVSE 22 when installing the combiner box 28.

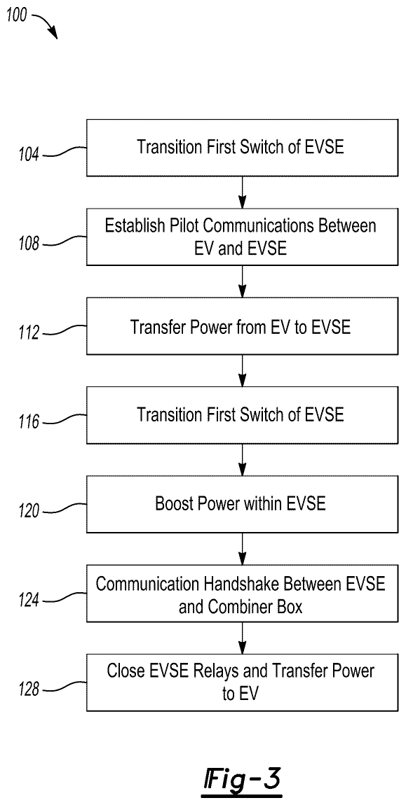

With reference to FIG. 3 and continuing reference to FIGS. 1 and 3, an exemplary power transfer method 100 begins at a step 104 where the power source 40 within the EVSE 22 transitions the first switch S1 to a closed state so that the power source 40 can begin to power a pilot signal to the electrified vehicle 12. Next, at a step 108, pilot communications are established with the electrified vehicle 12 and, in response, the EVSE 22 accepts 240 VAC from the electrified vehicle 12 through the SMPS 52 at a step 112.

At a step 116, the power source 40 transitions the first switch S1 back to an open state. The electrified vehicle 12 is then relied on to power the EVSE 22 and recharge the power source 40.

At a step 120, power from the electrified vehicle 12 is boosted within the EVSE 22 to, among other things, account for a voltage drop to the combiner box 28. Boosted power is then transferred to the combiner box 28 through, for example, a Power over Ethernet connection between the EVSE 22 and the combiner box 28.

At a step 124, a communication handshake occurs between the EVSE 22 and the combiner box 28 via the Power over Ethernet connection. In response, at a step 128, the EVSE 22 closes relays and begins to transfer 240 VAC power from the EVSE 22 to the electrified vehicle 12.

Features of some of the exemplary embodiments include a combiner box that does not need a battery as there is no need to keep the combiner box powered in a standby state. The combiner box can remain off until powered through the Power over Ethernet connection to the EVSE. The boost circuit within the EVSE can facilitate incorporating a smaller battery within the EVSE than what would otherwise be necessary for longer distances (i.e., distances more than 100 feet) between the EVSE and the combiner box. Voltage drops can be accommodated, at least in part, by the boost circuitry.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A bidirectional power transfer system, comprising:
a power source within EVSE;
a first switch that transitions to a closed state so that the power source within the EVSE can power communications between the EVSE and an electrified vehicle; and
a second switch that transitions to a closed state so that the power source can be recharged from the electrified vehicle.

2. The bidirectional power transfer system of claim 1, wherein the power source is a battery.

3. The bidirectional power transfer system of claim 2, wherein the battery is at least 13 Volts.

4. The bidirectional power transfer system of claim 1, wherein the power source is capacitor.

5. The bidirectional power transfer system of claim 4, wherein the power source is and ultracapacitor.

6. The bidirectional power transfer system of claim 1, wherein the EVSE includes the first switch, the second switch, or both.

7. The bidirectional power transfer system of claim 1, wherein communications from the EVSE to the electrified vehicle initiate a power transfer from the electrified vehicle, through the EVSE, to a structure that is operably coupled to the EVSE.

8. The bidirectional power transfer system of claim 7, further comprising a third switch that transitions to a closed state so that power from the electrified vehicle can be used to power communications between the EVSE and the structure.

9. The bidirectional power transfer system of claim 8, further comprising Ethernet cabling, the communications between the EVSE and the structure transferred along the Ethernet cabling.

10. The bidirectional power transfer system of claim 9, further comprising a switched-mode power supply within the EVSE, the switched-mode power supply powered by the power from the electrified vehicle.

11. The bidirectional power transfer system of claim 9, further comprising a boost circuit within the EVSE, the boost circuit boosting power received from the vehicle before transferring the power to the structure.

12. The bidirectional power transfer system of claim 9, wherein the EVSE is configured to operably couple to a combiner box of the structure when the EVSE is transferring power from the electrified vehicle, through the EVSE, to a structure that is operably couple to the EVSE.

13. The bidirectional power transfer system of claim 12, wherein the combiner is batteryless.

14. A power transfer method, comprising:
powering communications between EVSE and an electrified vehicle using a power source within the EVSE;
in response to the communications between the EVSE to the electrified vehicle, transferring power from the electrified vehicle through the EVSE to a structure; and
recharging the power source within the EVSE during the transferring using power from the electrified vehicle.

15. The power transfer method of claim 14, further comprising powering communications between the EVSE and the structure using power from the electrified vehicle.

16. The power transfer method of claim 14, further comprising transitioning a first switch to an closed state to enable the power source to power the communications between the EVSE and the electrified vehicle, and transitioning the first switch to an open state when transferring power from the electrified vehicle through the EVSE to the structure.

17. The power transfer method of claim 14, wherein the power source within EVSE is a battery that is no more than 13 Volts.

18. The power transfer method of claim 14, further comprising, during the transferring, powering communications between the EVSE and the structure using power transferred to the EVSE from the electrified vehicle.

19. The power transfer method of claim 18, wherein communications between the EVSE and the structure are Ethernet communications.

20. The power transfer method of claim 18, further comprising transitioning at least one second switch from an open state to a closed state to enable the powering of communications between the EVSE and the structure.
